(19) United States
(12) Patent Application Publication
(10) Pub. No.: US 2018/0192763 A1
(43) Pub. Date: Jul. 12, 2018

(54) STERILE APPLICATOR AND METHOD FOR APPLYING A TATTOO STENCIL

(71) Applicants: Damon Privett, Margate, FL (US); Perry Privett, Margate, FL (US)

(72) Inventors: Damon Privett, Margate, FL (US); Perry Privett, Margate, FL (US)

(21) Appl. No.: 15/403,743

(22) Filed: Jan. 11, 2017

(51) Int. Cl. A45D 44/00; A01N 31/02; B08B 1/00

(52) U.S. Cl. CPC A45D 44/00; B08B 1/006; A01N 31/02

(57) ABSTRACT

A sterile single-use applicator for applying a tattoo stencil. The applicator may be provided as an individually sealed, sterile, and a single use applicator that contains an antiviral, an antibacterial and a tattoo adhering compounds to hygienically apply a tattoo stencil. The anti-septic compositions prepare the skin surface to avoid the possibility of cross contamination while applying a tattoo.

### BACKGROUND OF THE INVENTION

The present invention relates to tattoo stencil application and, more particularly, apparatus and methods for sterile application of tattoo stencils to a recipient's skin surfaces.

In preparing a tattoo recipient's skin surfaces for applying a tattoo, particularly those where the tattoo artist is utilizing a stencil for a design selected by the recipient, it is customary to use an applicator so that the stencil is temporarily adhered to the recipient's skin.

Currently, most tattoo parlors reuse the same applicator (such as a deodorant stick) for reuse across multiple clients to applying a tattoo stencil. This practice is potentially harmful and can could lead to infection or the transmission of disease.

As can be seen, there is a need for an improved tattoo stencil applicator that contains antiviral and antibacterial compounds for the application of a tattoo stencil.

### SUMMARY OF THE INVENTION

In one aspect of the present invention, a tattoo preparation applicator, includes a handle portion; an applicator surface attached to the handle portion, the applicator surface having a medium carrier thereon; and a tattoo stencil adherent composition carried by the medium carrier. The applicator may also include an anti-septic composition carried by the medium carrier. The tattoo stencil adherent composition may be propylene glycol and the anti-septic composition may include isopropyl alcohol.

The handle portion may also include an applicator surface backing portion, which may be substantially disk shaped. The applicator may be carried in a wrapper to contain the applicator in a sealing enclosure.

Other aspects of the invention include a method of applying a tattoo stencil on a tattoo recipient. The method includes providing a tattoo preparation applicator, having a handle portion, an applicator surface attached to a forward end of the handle portion, with the applicator surface having a medium carrier. A skin preparation formula having a tattoo stencil adherent composition and an anti-septic composition is carried by the medium carrier. A skin surface of the recipient around an area to be tattooed is wiped with the applicator surface. The skin around the area to be tattooed may also be shaved with a razor. The tattoo stencil may then be applied to the area to be tattooed such that it is temporarily retained by the tattoo stencil adherent composition. The applicator may then be discarded in a waste receptacle. The anti-septic composition may be formulated with isopropyl alcohol and the stencil adherent composition may include propylene glycol.

These and other features, aspects and advantages of the present invention will become better understood with reference to the following drawings, description and claims.

### BRIEF DESCRIPTION OF THE DRAWINGS

FIG. 1 is a perspective view of an embodiment of a sterile applicator according to aspects of the present invention.

FIG. 2 is a schematic view of the embodiment of the sterile applicator show in use.

FIG. 3 is a flow chart of a method of using the sterile applicator.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved self-contained sterile applicator providing a sterile workspace and the temporary retention of a stencil on a tattoo recipient's skin surfaces.

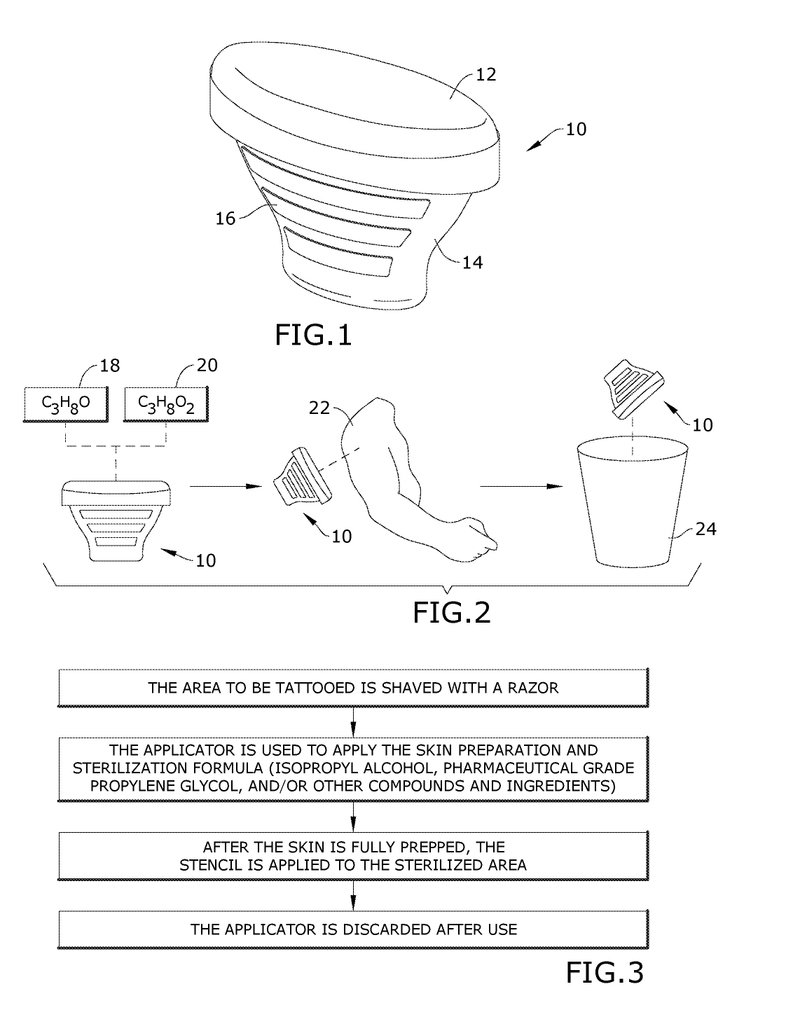

As seen in reference to FIG. 1, an embodiment of a sterile applicator 10 according to aspects of the invention is show. The applicator 10 includes an applicator surface 12, which includes a front surface having a medium carrier 15 to carry a disinfectant and tattoo application composition. A handle 14 extends from a back surface of the applicator 10, and may include an applicator backing support disk 17 to provide a reinforcement to the medium carrier 15. The handle 14 may also include a gripping surface 16 to facilitate holding of the applicator 10 while the disinfectant and application composition is applied to a recipient's skin.

The medium carrier may be formed of an absorbent fabric, porous foam material or combinations thereof that are suitable for releasably holding the disinfectant and stencil adherent composition. The handle 14 may be formed of any suitable material, such as plastic, cardboard, metal, and the like. The applicator 10 may be contained within a sealed wrapper, to maintain the sterility of the applicator 10 and prevent the evaporation of the disinfectant and stencil adherent composition. The applicator 10 and wrapper may each be formed of disposable materials.

The disinfectant and stencil adherent composition may include a sterilization formula including isopropyl alcohol, pharmaceutical grade propylene glycol, and other compounds and ingredients. The disinfectant composition may also include other topical anti-bacterial and anti-viral compositions. The ingredient profile could be altered to contain other compounds such as but not limited to antimicrobials, benzalkonium halides, chlorinated aromatic compounds and/or miconazole salts with the stencil adherent compound. Anti-hemorrhagic compounds such as microfibrillar collagen, chitosan, and styptics, such as anhydrous aluminum sulfate may also be included. The applicator 10, could be used by barbers to disinfect and stop bleeding with the addition of anhydrous aluminum sulfate.

The applicator composition of the compound would include suitable compounds that allow the temporary adherence of a tattoo stencil to a recipient's skin surface for the time that the tattoo artist is applying inks for the selected tattoo design.

As seen in reference to FIG. 2, a method of utilizing the applicator 10 is graphically illustrated. The applicator 10 is shown with a combination of a disinfecting ingredient 18, such as isopropyl alcohol and a tattoo stencil adherent composition 20, such as propylene glycol. The applicator 10 is used to apply the composition to the recipient's skin surface 22 to disinfect the skin surface and apply the stencil applicator composition 20. The applicator 10 may then be readily disposed of in a waste receptacle 24.

In further reference to FIG. 3, a flowchart of the method is provided. As a preliminary step, when necessary, the recipient's skin 22 around the site selected for the tattoo is shaved, preferably with a disposable razor. The applicator 10 is then used to apply the skin preparation and sterilization formula. After the skin 22 is prepared, the stencil is applied to the sterilized area and is temporarily adhered to the skin 22 by the tattoo artist and the tattoo is inked according to the selected procedures of the tattoo artist.

It should be understood, of course, that the foregoing relates to exemplary embodiments of the invention and that modifications may be made without departing from the spirit and scope of the invention as set forth in the following claims.

What is claimed is:

1. A tattoo preparation applicator, comprising:
a handle portion;
an applicator surface attached to the handle portion, the applicator surface having a medium carrier; and
a tattoo stencil adherent composition carried by the medium carrier.

2. The applicator of claim 1, further comprising:
an anti-septic composition carried by the medium carrier.

3. The applicator of claim 2, wherein the tattoo stencil adherent composition comprises propylene glycol.

4. The applicator of claim 3, wherein the anti-septic composition comprises isopropyl alcohol.

5. The applicator of claim 3, wherein the handle portion further comprises an applicator surface backing portion.

6. The applicator of claim 5, wherein the applicator backing portion is substantially disk shaped.

7. The applicator of claim 6, further comprising:
a wrapper to contain the applicator in a sealing enclosure.

8. A method of applying a tattoo stencil on a tattoo recipient, comprising:
providing a tattoo preparation applicator, comprising:
a handle portion;
an applicator surface attached to a forward end of the handle portion, the applicator surface having a medium carrier; and
a skin preparation formula having a tattoo stencil adherent composition and an anti-septic composition carried by the medium carrier;
wiping a skin surface of the recipient around an area to be tattooed by with the applicator surface.

9. The method of claim 8, further comprising:
shaving the area to be tattooed with a razor.

10. The method of claim 8, further comprising:
applying a tattoo stencil to the area to be tattooed.

11. The method of claim 10, further comprising:
discarding the tattoo preparation applicator in a waste receptacle.

12. The method of claim 8, wherein the anti-septic composition comprises isopropyl alcohol and the stencil adherent composition comprises propylene glycol.
